(19) United States
(12) Patent Application Publication
(10) Pub. No.: US 2015/0224979 A1
(43) Pub. Date: Aug. 13, 2015

(54) DRIVE MODE MODERATOR FOR A VEHICLE

(71) Applicant: GM GLOBAL TECHNOLOGY OPERATIONS LLC, Detroit, MI (US)

(72) Inventors: Daniel P. Grenn, Highland, MI (US); Andrew M. Zettel, Port Moody (CA)

(73) Assignee: GM GLOBAL TECHNOLOGY OPERATIONS LLC, Detroit, MI (US)

(21) Appl. No.: 14/175,103

(22) Filed: Feb. 7, 2014

(51) Int. Cl. B60W 20/00; G06Q 50/26; G06Q 50/30; G06Q 20/14

(52) U.S. Cl. CPC B60W 20/00; G06Q 20/145; G06Q 50/26; G06Q 50/30

(57) ABSTRACT

A vehicle includes an engine, a battery module, an electric motor-generator unit (MGU), and a controller. The engine generates an engine torque. The battery module stores and outputs electrical energy. The MGU is in electrical communication with the battery module and is configured to generate a motor torque based, at least in part, on the electrical energy received from the battery module. The MGU generates electrical energy. The controller is in communication with at least one powertrain module. The controller is configured to receive a signal corresponding to a selected drive mode of the vehicle; adjust an account balance of a credit account as a function of the selected drive mode; and transmit a signal to at least one of the engine, the battery module, and the MGU to allow the vehicle to operate in the selected drive mode.

### TECHNICAL FIELD

The present disclosure is related to a drive mode moderator for a vehicle.

### BACKGROUND

An electric vehicle, such as a hybrid electric vehicle (HEV), a plug-in hybrid electric vehicle (PHEV), or the like, generally includes an electric motor, which may alone propel the vehicle in an electric vehicle (EV), or charge-depleting, drive mode. The vehicle may also include an internal combustion engine (ICE) to serve as the primary propulsion system of the vehicle in a range extending mode, or to operate in conjunction with the electric motor in a hybrid, or charge-sustaining, mode.

The electric motor generally receives electric power from an electric power source, such as an energy storage system (ESS). The ESS may include a battery pack or other rechargeable energy storage means capable of storing large amounts of thermal energy. The ESS may store the thermal energy when the vehicle is connected to an external power source, such as an electrical grid, for charging. In colder ambient temperatures, the charge depletes faster, due to various factors.

### SUMMARY

One possible aspect of the disclosure provides a method of moderating a drive mode of a vehicle. The method includes receiving a signal corresponding to a selected drive mode of the vehicle. An account balance of a credit account is adjusted as a function of the selected drive mode. A signal is transmitted from a controller to at least one powertrain module to allow the vehicle to operate in the selected drive mode.

In another aspect of the disclosure, a vehicle includes an engine, a battery module, an electric motor-generator unit (MGU), and a controller. The engine is configured to generate an engine torque. The battery module is configured to store and output electrical energy. The MGU is in electrical communication with the battery module and is configured to generate a motor torque based, at least in part, on the electrical energy received from the battery module. The MGU is further configured to generate electrical energy. The controller is in communication with the engine, the battery module, and the MGU. The controller is configured to receive a signal corresponding to a selected drive mode of the vehicle; adjust an account balance of a credit account as a function of the selected drive mode; and transmit a signal to at least one of the engine, the battery module, and the MGU to allow the vehicle to operate in the selected drive mode.

In another aspect of the disclosure a drive mode moderator (DMM) is configured for moderating a drive mode in a vehicle. The DMM includes a menu display. The menu display presents at least one selector switch corresponding to a drive mode in the vehicle. The selector switch is configured for being selected by an operator of the vehicle. The selection of the selector switch is configured to transmit a signal corresponding to a selected drive mode of the vehicle to a controller; adjust an account balance of a credit account as a function of the selected drive mode; and transmit a signal from the controller to at least one powertrain module to allow the vehicle to operate in the selected drive mode.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic diagrammatic view of a vehicle including a drive mode moderator (DMM).

FIG. 2 is a schematic view of the DMM of FIG. 1 including a menu display having a plurality of switches and presenting information.

FIG. 3 is an example flow chart for a method of moderating a drive mode of the vehicle.

FIG. 4 is an example flow chart for a steering algorithm for initiating a mode moderator algorithm for a mountain mode at step 114 in FIG. 3

FIG. 5 is an example flow chart for a steering algorithm for initiating a mode moderator algorithm for a hold mode at step 114 in FIG. 3

FIG. 6 is an example flow chart for a steering algorithm for initiating a mode moderator algorithm for an electric vehicle (EV) mode at step 114 in FIG. 3

FIG. 7 is an example flow chart for a steering algorithm for initiating a mode moderator algorithm for a super sport mode at step 114 in FIG. 3.

FIG. 8 is an example flow chart for a steering algorithm for initiating a mode moderator algorithm for a winter mode at step 114 in FIG. 3

FIG. 9 is a schematic graphical representation, illustrating earning and spending credits while operating the vehicle during different drive cycles.

FIG. 10 is another schematic graphical representation, illustrating earning and spending credits while operating the vehicle during different drive cycles.

### DETAILED DESCRIPTION

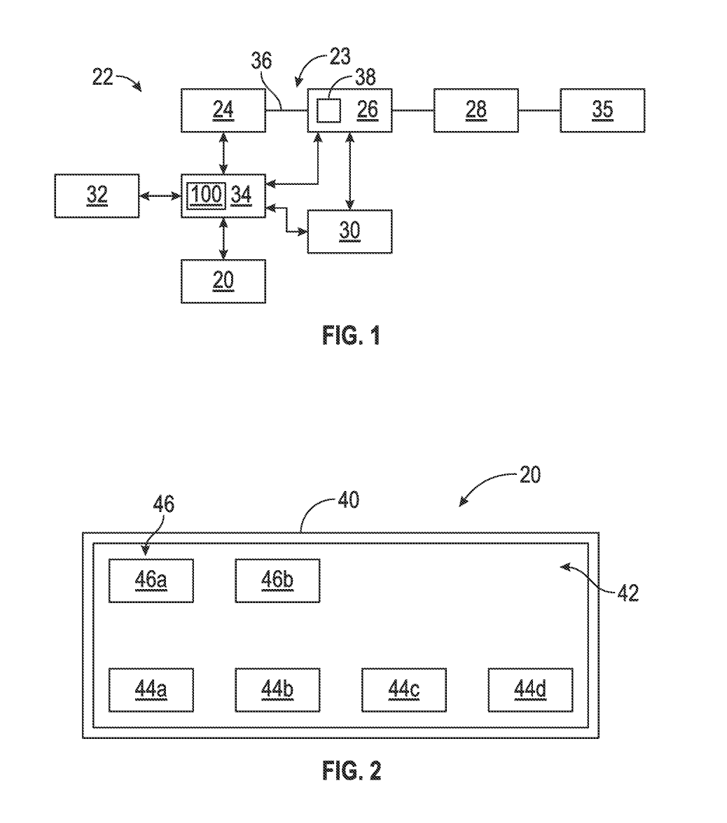

Referring to the drawings, wherein like reference numbers correspond to like or similar components wherever possible throughout the several figures, a drive mode moderator 20 (DMM) for use in any passenger or commercial vehicle 22, including, but not limited to, a hybrid electric vehicle (HEV), a plug-in hybrid electric vehicle (PHEV), and the like, is shown in FIG. 1. As will be explained in more detail below, the DMM 20 is configured to moderate driver usage of drive modes of the vehicle 22 using a credit/debit system intended to incentivize driving habits that are energy efficient and/or less impactful to the environment and disincentivize energy driving habits that are energy inefficient and/or more impactful to the environment. The vehicle 22 may include a plurality of powertrain modules 23, which may include, but not be limited to, an engine 24, an electric motor-generator unit 26 (MGU), a gear box 28, a power source such as a high-voltage battery module 30, the DMM 20, and a parameter sensor 32. The vehicle 22 may also include a controller 34 in operative communication with the powertrain modules 23. The engine 24 and the MGU 26 are configured to selectively propel wheels 35 of the vehicle 22.

The engine 24 may include any device which generates rotational motion from combusted fuel to produce engine torque. In one possible approach, the engine 24 may be an internal combustion engine 24 configured to combust a mixture of fuel and air in accordance with an Otto cycle, a Diesel cycle, or any other thermodynamic cycle. The engine torque may be output by the engine 24 via a crankshaft 36.

The battery module 30 may include any device configured to store and/or output electrical energy. For instance, the battery module 30 may include one or more electrochemical cells that are each configured to convert stored chemical energy into electrical energy. In one possible approach, the battery module 30 may be configured to output direct current (DC) energy. An inverter (not shown) may convert the DC electrical energy into alternating current (AC) energy to provide electrical energy to devices used with the vehicle 22 that may operate using AC energy. The inverter may output three-phase AC energy. The battery module 30 may also or alternatively include a rectifier (not shown) to convert AC energy generated by one or more vehicle 22 components into DC energy that may be stored in the battery. Both the inverter and the rectifier may be part of the battery module 30 or may be separate components within the vehicle 22.

The battery module 30 may store and output electrical energy, such as DC energy, in accordance with a state of charge (SOC). Therefore, the SOC may indicate the amount of electrical energy remaining in, or the amount available from, the battery module 30. The term “actual state of charge” may refer to the amount of electrical energy stored in the battery module 30 at any particular time and the term “nominal state of charge” may refer to a commanded nominal SOC based on, e.g., the current operating mode of the vehicle 22. Accordingly, the battery module 30 may be charged when the actual SOC falls below a nominal SOC or depleted when the actual SOC is above the nominal SOC. As understood in the art, SOC is typically limited to a range above and below the respective fully-depleted/fully-charged levels to maximize battery life.

The MGU 26 generates rotational motion or motor torque from electrical energy. To receive the electrical energy, the MGU 26 may be in either direct or indirect electrical communication with the battery module 30. That is, the motor may receive either DC energy output by the battery module 30 or AC energy output by the inverter.

The battery module 30 may be recharged using the electrical grid, i.e., using wall power. Alternatively, the MGU 26 may act as a generator. For example, the MGU 26 may be selectively coupled to the engine 24 to receive the engine 24 torque and generate electrical energy to recharge the battery module 30 in accordance with the engine 24 torque received. The MGU 26 may be selectively coupled to the engine 24 via a clutch (not shown) that, when engaged, is configured to transfer the engine 24 torque to the MGU 26.

Alternatively, the MGU 26 may act as a generator during a regenerative braking procedure. That is, as the vehicle 22 is braking, the MGU 26 may convert the kinetic energy of the vehicle 22 into electrical energy. The electrical energy generated by the MGU 26 may be stored in the battery module 30. In one non-limiting example, the MGU 26 may be configured to generate AC energy that may be converted into DC energy by the rectifier and stored as DC energy in the battery module 30. A motor control unit 38 may control the operation of the MGU 26.

Referring to FIG. 2, the DMM 20 may include any device presenting information and/or queries to a user of the vehicle 22 as well as receive inputs from the user. By way of a non-limiting example, the DMM 20 may include a housing 40 having a menu display 42 that is configured to present at least one selector switch 44 for the operator to select a corresponding drive mode. An exemplary DMM 20 may include switches 44a, 44b, 44c, 44d indicating a mountain mode switch 44a, a hold mode switch 44b, an EV mode switch 44c, s super sport switch 44d, and the like. The menu display 42 may also present information 46, including, but not limited to, a current drive mode 46a, an account balance 46b, and the like. Operation of the drive modes and the DMM 20 will be explained in more detail below.

The parameter sensor 32 may include any device configured to identify an operating condition of the vehicle 22. The operating conditions identified by the parameter sensor 32 may include, but should not be limited to, a geographic location, ambient temperature, altitude, and the like. The location may be determined by any number of satellites, cellular towers, or any other telecommunications landmarks to identify the location of the vehicle 22. Accordingly, in one possible implementation, the identification of the location may be implemented in a Global Positioning System (GPS), using On Star®, etc.

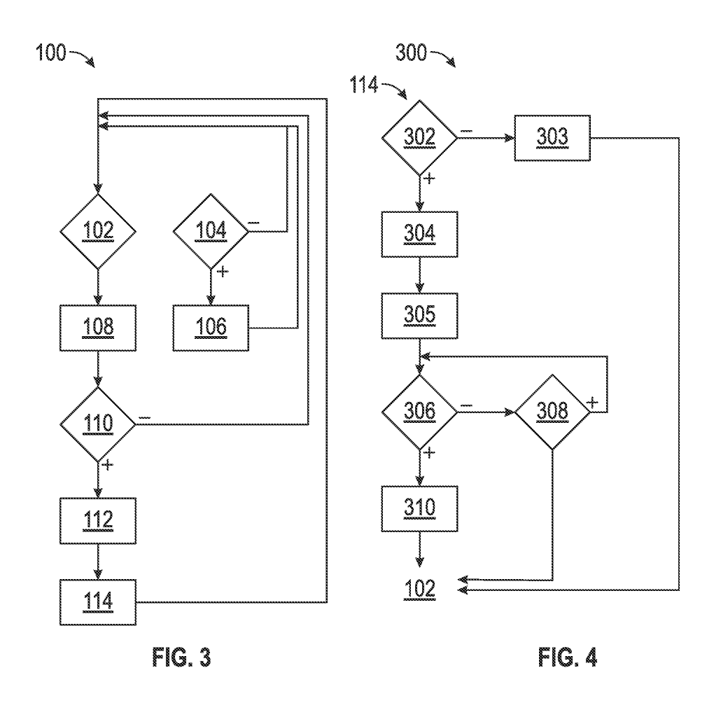

The controller 34 is programmed with, or has access to, an algorithm or method 100, the execution of which provides a method of moderating a drive mode of the vehicle 22, with the algorithm explained in detail below and as shown in FIG. 3. The controller 34 may include any device in communication with the powertrain modules 23, including, but not limited to, the battery module 30, the engine 24, the MGU 26, the DMM 20, the parameter sensor 32, and the like. The DMM 20 is configured to moderate vehicle 22 operation in one or more drive modes, including, but not limited to, a mountain mode, hold mode, electric vehicle 22 (EV) mode, super sport mode, normal mode, winter mode, and the like. The mountain mode may be used in vehicle 22 operation associated with ascending and descending mountains. The hold mode may be used to operate in an engine 24 only vehicle 22 operating mode, so that all electrical operation may be used at a later time, but preferably before the battery module 30 is recharged using the grid. The EV mode is an electric-only mode that may be used to prevent the engine 24 from starting, for as long as possible, as a function of conservative driving habits of the vehicle 22 operator, e.g., “hypermiling” and the like. In the EV mode, the vehicle 22 operates using only energy stored in the battery module 30. Once the energy stored in the battery module 30 is drained to a predetermined level, the engine 24 may start to continue operating the vehicle 22. The super sport mode may be used when the operator wants more aggressive acceleration performance, not otherwise achievable in the other drive modes. Normal mode may be used to operate first with only the MGU 26 until all electricity of the battery module 30 is exhausted and then with the engine 24 when no electricity in the battery remains. The winter mode may be used when the ambient temperature is no greater than a minimum level, e.g., 0 degrees Celsius. The winter mode may be part of an automatic drive mode whereby the parameter sensor 32 determines the operating conditions of the vehicle 22 and automatically selects a drive mode corresponding to the sensed operating conditions. It should be appreciated that more or less drive modes may be used.

Some states, cities, or countries require a certification of the vehicle 22 in order to sell or otherwise operate the vehicle 22. In order to be certified, vehicle manufacturers may be required to provide a vehicle 22 that performs in a prescribed manner. This performance may include, but should not be limited to, not exceeding a defined emissions level, not exceeding a defined noise level, achieving a defined fuel economy, and the like. In order to achieve such a certification, the vehicle manufacturer may be required to test the vehicle 22 under a certification drive cycle to prove the vehicle 22 performs as prescribed.

Some vehicles 22 may be configured to operate in a different number of selectable drive modes. In such instances, not every selectable drive mode may operate in the prescribed manner. If the vehicle 22 is configured to operate in a different number of selectable drive modes, and one or more of these selectable drive modes would not be acceptable under the certification drive cycle, the DMM 20 may be configured to include a credit/debit system where the operator or the vehicle 22 has an account having an account balance. The credit/debit system is configured to credit operators for driving with “green”, i.e., energy efficient, fuel efficient, quieter, driving habits that are less impactful on the environment and debit the credit account or not credit the credit account for driving with “non-green”, i.e., non-energy, non-fuel efficient, louder, driving habits that are more impactful on the environment. Such a credit/debit system is configured to discourage non-green driving habits and the vehicle manufacturer may be required to provide statistical data to show that such non-green driving occurs infrequently, as a result of the credit/debit system, while still allowing the vehicle manufacturer to provide vehicle 22 features that drive customer enthusiasm of new technologies.

As such, the DMM 20 may be configured to maintain an account balance of credits available to be used by the vehicle 22 when driving in the selected drive mode. The DMM 20 may be configured to debit credits from the operators account when certain types of the drive modes are selected during the vehicle 22 drive cycle. The drive cycle may be defined as the elapsed time from turning the vehicle 22 on to the time of turning the vehicle 22 off. The account may be configured to receive credits when clean source energy is transferred from the grid to the battery module 30. It should be appreciated that this method of credit accumulation may assume future usage of a clean source of energy. Also, the account may be configured to receive credits if the EV drive mode was selected and the engine 24 did not start during a corresponding drive cycle. Additionally, the DMM 20 may use the GPS location to verify that if mountain mode was selected during the drive cycle, the mode was selected appropriately. If the DMM 20 determines the mountain mode was selected and should not have been selected, a debit would be charged to the account. However, if the DMM 20 determines the mountain mode was properly selected, the account may be not be debited.

It should be appreciated that the DMM 20 may be configured such that one or more drive modes do not have any debits associated with their usage and the vehicle 22 may always be able to operate in these drive modes when there is an insufficient credit balance in the account. Further, the DMM 20 may be configured to receive credits to be used with operation of the vehicle 22 through other actions besides driving in certain drive modes. By way of a non-limiting example, the DMM 20 may be configured to receive credits from accounts associated with other vehicles 22 or other operators. These credits may be credited to the account wirelessly or through other data transfer means, as known to those of skill in the art. Likewise, the DMM 20 may be configured such that credits may be sold or traded to other vehicles 22 or other accounts.

Still referring to FIG. 1, the controller 34 may be configured to employ any of a number of computer operating systems and generally include computer-executable instructions, where the instructions may be executable by one or more computers. Computer-executable instructions may be compiled or interpreted from computer programs created using a variety of well-known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With respect to the operation of the controller 34 in execution of the method 100, the method may begin at step 102, wherein the controller 34 determines if the vehicle 22 is in a charging mode with the vehicle 22 plugged into an energy source. If the vehicle 22 is in the charging mode, the method proceeds to step 104 to determine if the battery is being charged. If it is determined that the battery is not being charged, the method proceeds back to step 102. However, if it is determined that the battery is being charged, the method proceeds to step 106. At step 106, credits may be added to the credit account. The quantity of credits may be added to the account as a function of the length of time the vehicle 22 is being charged or the amount of charge to the battery. Once the credits are added to the credit account, the method proceeds back to step 102.

Once the controller 34 determines at step 102 that the vehicle 22 is not in a charging mode, the method proceeds to step 108 where a status of the vehicle 22 is determined. A status of the vehicle 22 may be whether the vehicle 22 is activated or otherwise started, e.g., “keyed on” or whether the vehicle 22 is deactivated or otherwise turned off, e.g., “keyed off”.

The controller 34 then determines at step 110 if the status of the vehicle 22 is activated. If the status of the vehicle 22 is determined to be deactivated, the method returns to step 102. If the status of the vehicle 22 is determined to be activated, the method proceeds to step 112. At step 112, a selected drive mode is received by the controller 34. As discussed previously, the drive mode may be a mountain mode, a hold mode, an EV mode, a super sport mode, a winter mode, and the like.

The method proceeds to step 114 to initiate a mode moderator algorithm 300, 400, 500, 600, 700, corresponding to the selected drive mode of the vehicle 22. The mode moderator algorithm 300, 400, 500, 600, 700 may correspond to the mountain mode, the hold mode, the EV mode, the super sport mode, and the winter mode, respectively, which are all executed by the master controller 34 at step 114. Generally, the mode moderator algorithm 300, 400, 500, 600, 700 controls one or more of the powertrain modules 23, including, but not limited to, the engine 24, the MGU 26, gear box 28, the battery module 30, the DMM 20, and the like. The mode moderator algorithm 300, 400, 500, 600, 700 also controls the credit account of the credit/debit system to operate in the selected drive mode. The operation of each of the mode moderator algorithms 300, 400, 500, 600, 700 will be described in turn below.

With reference to FIGS. 3 and 4, when the mountain mode is selected, the mode moderator algorithm 300 is executed at step 114. The mode moderator algorithm 300 for the mountain mode begins at step 302, where a determination is made as to whether the credit account balance is greater than the credit cost of operating in the mountain mode. If the determination is made that the credit account balance is not greater than the credit cost of operating in the mountain mode, i.e., there is an insufficient credit balance, the method may proceed to step 303, where a message is reported to the operator of the vehicle 22 that there is an insufficient credit balance in the credit account. Following the reporting of the message to the operator at step 303, the method exits the mode moderator algorithm 300 and returns to step 102.

If, however, the determination is made that the credit account balance is at least equal to the credit cost of operating in the mountain mode, i.e., there is a sufficient credit balance, the method proceeds to step 304.

At step 304, the number of credits, or otherwise the cost of operating in the mountain mode, is subtracted from the credit account.

Next, at step 305, the controller 34 may transmit a signal to one or more of the powertrain modules 23 to allow the vehicle 22 to operate in the selected operating mode. As described above, the signal may be transmitted to at least one of the engine 24, the MGU 26, the battery module 30, the DMM 20, and the parameter sensor 32.

Next, the method may proceed to step 306, where a determination as to whether the required grade has been ascended by the vehicle 22 while operating in the mountain mode. This determination may be made based on the coordinate position of the vehicle 22, as determined by GPS, On Star, and the like. If a determination is made that the vehicle 22 has not ascended the required grade, the method proceeds to step 308. At step 308, a determination is made as to whether the mountain mode is still the selected operating mode. If a determination is made at step 308 that the mountain mode is still the selected mode, the method returns to step 306 to again determine whether the vehicle 22 has ascended the required grade. If, however, a determination is made at step 308 that the mountain mode is no longer the selected operating mode, the method exits the mode moderator algorithm 300 and returns to step 102.

Once a determination is made in the mode moderator algorithm 300 that the vehicle 22 has ascended the required grade, the method proceeds to step 310. At step 310, credits are added back to the credit account. The number of credits may be equal to the number of credits that were deducted from the account at step 304 or the number of credits may be some other desired number of credits.

Once the credits are added back to the credit account at step 310, the method exits the mode moderator algorithm 300 and returns to step 102.

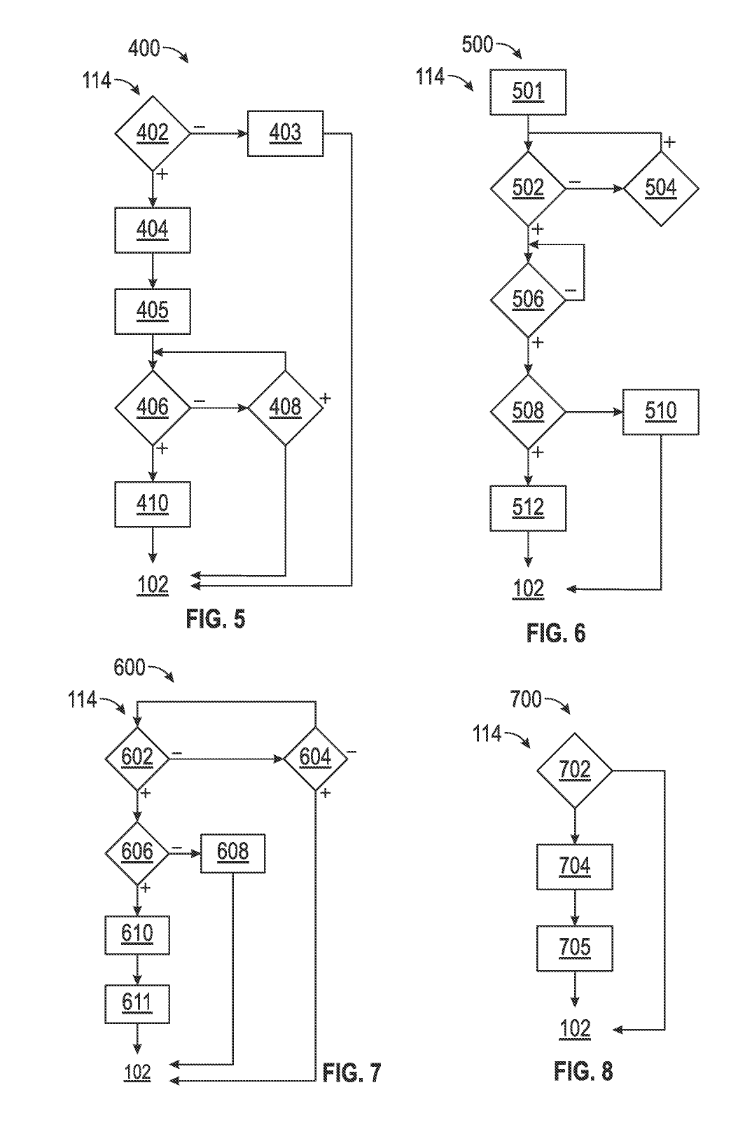

With reference to FIGS. 3 and 5, when the hold mode is selected, the mode moderator algorithm 400 is executed at step 114. The mode moderator algorithm 400 for the hold mode begins at step 402, where a determination is made as to whether the credit account balance is greater than the credit cost of operating in the hold mode. If the determination is made that the credit account balance is not greater than the credit cost of operating in the hold mode, i.e., there is an insufficient credit balance, the method may proceed to step 403, where a message is reported to the operator of the vehicle 22 that there is an insufficient credit balance in the credit account. Following the reporting of the message to the operator at step 403, the method exits the mode moderator algorithm 400 and returns to step 102.

If, however, the determination is made that the credit account balance is at least equal to the credit cost of operating in the hold mode, i.e., there is a sufficient credit balance, the method proceeds to step 404.

At step 404, the number of credits, or otherwise the cost of operating in the hold mode, is subtracted from the credit account.

Next, at step 405, the controller 34 may transmit a signal to one or more of the powertrain modules 23 to allow the vehicle 22 to operate in the selected operating mode.

Next, the method may proceed to step 406, where a determination of whether an EV range since the last plug-in charge of the vehicle 22 is near zero miles. This determination may be made by sensing a charge of the battery module 30. If a determination is made that the vehicle 22 does not have an EV range of near zero miles, the method proceeds to step 408. At step 408, a determination is made as to whether the hold mode is still the selected operating mode. If a determination is made at step 408 that the hold mode is still the selected mode, the method returns to step 406 to again determine whether the vehicle 22 has an EV range since the last plug-in charge of the vehicle 22 that is near zero miles. If, however, a determination is made at step 408 that the hold mode is no longer the selected operating mode, the method exits the mode moderator algorithm 400 and returns to step 102.

Once a determination is made in the mode moderator algorithm 400 that the vehicle 22 has an EV range since the last plug-in charge of the vehicle 22 to be near zero miles, the method proceeds to step 410. At step 410, credits are added back to the credit account. The number of credits may be equal to the number of credits that were deducted from the account at step 404 or the number of credits may be some other desired number of credits.

Once the credits are added back to the credit account at step 410, the method exits the mode moderator algorithm 400 and returns to step 102.

With reference to FIGS. 3 and 6, when the EV mode is selected, the mode moderator algorithm 500 is executed at step 114. The mode moderator algorithm 500 for the EV mode begins at step 501 where the controller 34 may transmit a signal to one or more of the powertrain modules 23 to allow the vehicle 22 to operate in the selected operating mode.

Next, at step 502, a determination is made as to whether the vehicle 22 has been driven in the EV mode an amount of miles which are greater than a required number of miles since the last plug-in charge of the vehicle 22. If the determination is made that the vehicle 22 has not been driven in the EV mode an amount of miles which are greater than a required number of driving miles since the last plug-in charge of the vehicle 22, the method proceeds to step 504. At step 504, a determination is made as to whether the EV mode is still the selected operating mode. If a determination is made at step 504 that the EV mode is no longer the selected operating mode, the method exits the mode moderator algorithm 500 and returns to step 102. If, however, a determination is made at step 504 that the EV mode is still the selected operating mode, the method returns to step 502 to again determine whether the vehicle 22 has been driven in the EV mode an amount of miles which are greater than a required number of miles since the last plug-in charge of the vehicle 22.

If a determination is made at step 504 that the vehicle 22 has been driven in the EV mode an amount of miles which are greater than a required number of miles since the last plug-in charge of the vehicle 22, the method proceeds to step 506.

At step 506, a determination is made by the controller 34 as to whether the drive cycle has ended. If the determination is made that the drive cycle has not ended, step 506 repeats. If, however, the determination is made that the drive cycle has ended, the method proceeds to step 508.

At step 508, a determination is made by the controller 34 as to whether the engine 24 has been off for the entire drive cycle. If a determination is made at step 508 that the engine 24 was not off for the entire drive cycle, the method proceeds to step 510 which may display a message to the operator that an EV bonus credit was not issued for the previous drive cycle due to usage of the engine 24 during the drive cycle. If, however, a determination is made at step 508 that the engine 24 was off during the entire drive cycle, the method proceeds to step 512.

At step 512, an EV bonus credit may be issued and added to the credit account balance. Once the EV bonus is credited, the method exits the mode moderator algorithm 500 and returns to step 102.

With reference to FIGS. 3 and 7, when the super sport mode is selected, the mode moderator algorithm 600 is executed at step 114. The mode moderator algorithm 600 for the super sport mode begins at step 602, where a determination is made as to whether the super sport mode has been selected since the last time of the vehicle's 22 last plug-in charge.

If a determination is made that the super sport mode has been selected since the last time of the vehicle's 22 plug-in charge, the method proceeds to step 604. At step 604, a determination is made as to whether the super sport mode is still the selected operating mode. If a determination is made at step 604 that the super sport mode is still the selected mode, the method returns to step 602 to again determine whether the super sport mode has been selected since the last time of the vehicle's 22 plug-in charge. Likewise, if a determination is made at step 604 that the super sport mode is no longer the selected mode, the method exits the mode moderator algorithm 600 and returns to step 102. If, however, a determination is made at step 602 that the super sport mode has not been selected since the vehicle's 22 last plug in charge, the method proceeds to step 606.

As step 606, a determination is made as to whether the credit account balance is greater than the credit cost of operating in the super sport mode. If the determination is made that the credit account balance is not greater than the credit cost of operating in the super sport mode, i.e., there is an insufficient credit balance, the method may proceed to step 608, where a message is reported to the operator of the vehicle 22 that there is an insufficient credit balance in the credit account. Following the reporting of the message to the operator at step 608, the method exits the mode moderator algorithm 600 and returns to step 102.

If, however, the determination is made that the credit account balance is at least equal to the credit cost of operating in the super sport mode, i.e., there is a sufficient credit balance, the method proceeds to step 610.

At step 610, the number of credits, or otherwise the cost of operating in the super sport mode, are subtracted from the credit account.

Next, at step 611, the controller 34 may transmit a signal to one or more of the powertrain modules 23 to allow the vehicle 22 to operate in the selected operating mode.

Next, the method exits the mode moderator algorithm 600 and returns to step 102.

With reference to FIGS. 3 and 8, when the winter mode is the selected mode, the mode moderator algorithm 700 is executed at step 114. It should be appreciated that the selection of the winter mode may be automatically initiated by the DMM 20 as a function of the ambient temperature. Further the winter mode may be similarly automatically unselected such that another operating mode is selected or selectable to the operator once certain parameters are met. These parameters may include, but should not be limited to, the ambient temperature achieving a requisite minimum temperature, fluids within the vehicle 22 achieving a requisite minimum temperature, a temperature of a passenger cabin within the vehicle 22 achieving a requisite minimum temperature, a time and/or mileage of operation, and the like.

The mode moderator algorithm 700 for the winter mode begins at step 702, where a determination is made as to whether coolant in the engine 24 is less than a minimum temperature required for producing heat for the passenger cabin. If the determination is made at step 702 that the temperature is not less than a required temperature, the method exits the mode moderator algorithm 700 and returns to step 102.

If, however, the determination is made at step 702 that the temperature of the coolant is less than a required temperature, the method proceeds to step 704 where the hold mode is automatically selected by the DMM 20. Next, at step 705, the controller 34 may transmit a signal to one or more of the powertrain modules 23 to allow the vehicle 22 to operate in the hold mode.

Once in the hold mode, the engine 24 operates to warm the temperature of the coolant to be at least equal to the desired minimum temperature. In one embodiment, the vehicle 22 remains in the automatically selected hold mode until a requisite minimum temperature of the coolant and/or passenger cabin is attained.

Once the requisite minimum temperature is attained, the vehicle 22 may remain in the hold mode until another operating mode is selected. Alternatively, once the requisite minimum temperature is attained, the vehicle 22 may exit the mode moderator algorithm 700 and return to step 102 such that the operator may select another operating mode. In yet another embodiment, once the requisite minimum temperature is attained, the operator may be given a choice to remain in the hold mode, whereby the mode moderator algorithm 400, corresponding to the hold mode, is initiated. In another embodiment, once the requisite minimum temperature is attained, the method exits the mode moderator algorithm 700 and returns to step 112 whereby the operator is given the choice to select another operating mode.

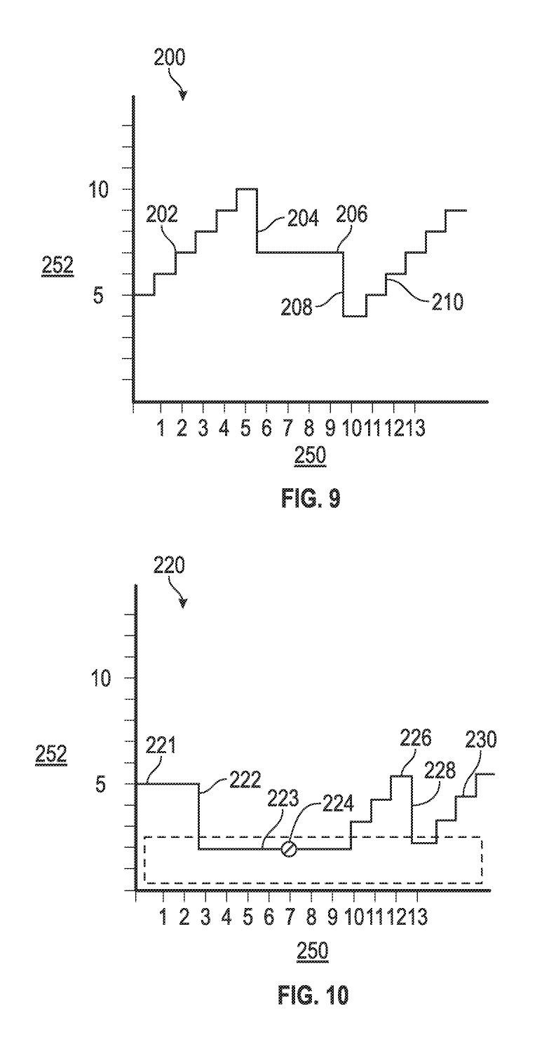

Referring to one non-limiting example, the credit/debit system is illustrated in FIG. 9. The credit/debit system illustrated in FIG. 9 is a graphical representation 200 that illustrates earning and spending credits from an account balance 252 while operating the vehicle 22 during different drive cycles 250. Referring to element 202 of the graphical representation 200, for two days, the operator plugs the vehicle 22 in for full battery module 30 charges on each of five fifty-mile trips. As a result, a credit is earned for each full battery module 30 charge, totaling five credits earned. Next, element 204 represents the operator choosing to drive the vehicle 22 using the super sport mode, resulting in three credits being deducted from the balance 252 of the credit account.

Next, element 206 represents the operator spending time where the vehicle 22 has not been charged, as no charging was available. The operator then drives the vehicle 22 three full drive cycles 250 in a charge sustaining mode, such that the charge of the battery module 30 is not depleted. As a result, the balance 252 of the credit account is not changed.

Then, element 208 represents the operator selecting to drive in the super sport mode, where three credits are deducted from the balance 252 of the credit account. As a result, the credit balance 252 is reduced to four credits.

Next, element 210 represents the operator charging the battery module 30 and driving five more drive cycles 250, thus earning one credit for each charge between drive cycles.

Referring to another non-limiting example, the credit/debit system illustrated in FIG. 10. The credit/debit system illustrated in FIG. 10 is a graphical representation 220 that illustrates earning and spending credits from an account balance of the credit account such that the account balance 252 becomes depleted to the point where the only drive mode available to the operator may be the EV mode. Referring to element 221, the operator is driving the vehicle 22 in a charge sustaining mode, i.e., a mode that sustains the charge of the battery module 30 by using fuel. Element 222 illustrates that after several drive cycles 250, the operator attempts to select the super sport mode and drives for a drive cycle 250 in the super sport mode, where the account balance is deleted to having only two credits available in the credit account 252. Element 223 illustrates the continued operation in the super sport mode, while having only two credits available in the credit account 252.

Element 224 illustrates the account balance having an insufficient number of credits available to continue operation in the super sport mode. The operator may be instructed by the DMM 20 to complete a requisite number of full charges of the battery module before super sport mode may be enabled.

Element 226 illustrates the operator charging the vehicle 22 the requisite number of charge cycles, such that three credits are earned. Element 228 illustrates the operator selecting and driving the vehicle 22 in the super sport mode. Element 230 illustrates the operator charging the battery module 30 the requisite number of charge cycles, such that three more credits are earned. It should be appreciated that vehicle 22 may operate in any desired order of drive sequences.

While the best modes for carrying out the many aspects of the present teachings have been described in detail, those familiar with the art to which these teachings relate will recognize various alternative aspects for practicing the present teachings that are within the scope of the appended claims.

1. A method of moderating a drive mode of a vehicle, the method comprising:
receiving a signal corresponding to a selected drive mode of the vehicle;
adjusting an account balance of a credit account as a function of the selected drive mode; and
transmitting a signal from a controller to at least one powertrain module to allow the vehicle to operate in the selected drive mode.

2. A method, as set forth in claim 1, further comprising determining a status of the vehicle to be an activated status;
wherein receiving a signal corresponding to a selected drive mode is further defined as receiving a signal corresponding to a selected drive mode of the vehicle when the status of the vehicle is determined to be an activated status.

3. A method, as set forth in claim 2, wherein adjusting an account balance of a credit account is further defined as adjusting an account balance of a credit account as a function of the selected drive mode when the status of the vehicle is determined to be an activated status.

4. A method, as set forth in claim 1, further comprising:
determining the vehicle is in a charging mode, such that a battery module is being charged; and
adjusting the account balance of the credit account as a function of determining the vehicle is in the charging mode.

5. A method, as set forth in claim 4, further comprising determining the account balance of the credit account.

6. A method, as set forth in claim 5, further comprising displaying a message on a menu display when the account balance of the credit account is determined to not be greater than a credit cost of operating in the selected drive mode.

7. A method, as set forth in claim 5, wherein adjusting the account balance is further defined as deducting the cost of operating in the selected drive mode from the credit account when the account balance of the credit account is determined to be at least equal to the credit cost of operating in the selected drive mode.

8. A method, as set forth in claim 5, wherein transmitting a signal from the controller to at least one powertrain module is further defined as transmitting a signal from the controller to at least one powertrain module to allow the vehicle to operate in the selected drive mode when the account balance of the credit account is determined to be at least equal to the credit cost of operating in the selected drive mode.

9. A method, as set forth in claim 8, further comprising:
determining a required parameter has been attained when driving in the selected drive mode; and
crediting the credit account with a credit when the required parameter is determined to have been attained when driving in the selected drive mode.

10. A method, as set forth in claim 1, further comprising determining the vehicle has been driven in an electric vehicle (EV) mode an amount of miles which are greater than a required number of miles since a last plug-in charge of a battery module.

11. A method, as set forth in claim 10, further comprising:
determining, by the controller, the engine was off during an entire drive cycle; and
crediting the credit account with a credit when the engine is determined to have been off during the entire drive cycle.

12. A vehicle comprising:
an engine configured to generate an engine torque;
a battery module configured to store and output electrical energy;
an electric motor-generator unit (MGU) in electrical communication with the battery module, and configured to generate a motor torque based at least in part on the electrical energy received from the battery module, wherein the MGU is further configured to generate electrical energy; and
a controller in communication with the engine, the battery module, and the MGU, wherein the controller is configured to:
receive a signal corresponding to a selected drive mode of the vehicle;
adjust an account balance of a credit account as a function of the selected drive mode; and
transmit a signal to at least one of the engine, the battery module, and the MGU to allow the vehicle to operate in the selected drive mode.

13. A vehicle, as set forth in claim 12, wherein the controller is further configured to determine a status of the vehicle to be an activated status;
wherein the received signal corresponding to a selected drive mode is further defined as being configured to receive a signal corresponding to a selected drive mode of the vehicle when the status of the vehicle is determined to be an activated status.

14. A vehicle, as set forth in claim 12, wherein the controller is further configured to:
determine a vehicle is in a charging mode, such that a battery module is being charged; and
adjust the account balance of the credit account as a function of determining the vehicle is in the charging mode.

15. A vehicle, as set forth in claim 14, wherein the controller is further configured to determine the account balance of the credit account.

16. A vehicle, as set forth in claim 15, wherein the controller is further configured to display a message on a menu display when the account balance of the credit account is determined to not be greater than a credit cost of operating in the selected drive mode.

17. A vehicle, as set forth in claim 15, wherein the controller is configured to adjust the account balance is further defined as the controller is configured to deduct the cost of operating in the selected drive mode from the credit account when the account balance of the credit account is determined to be at least equal to the credit cost of operating in the selected drive mode.

18. A vehicle, as set forth in claim 15, wherein the controller is configured to transmit a signal is further defined as transmitting a signal to at least one of the engine, the battery module, and the MGU to allow the vehicle to operate in the selected drive mode when the account balance of the credit account is determined to be at least equal to the credit cost of operating in the selected drive mode.

19. A drive mode moderator (DMM) configured for moderating a drive mode in a vehicle, the DMM comprising:
a menu display presenting at least one selector switch corresponding to a drive mode in the vehicle;
wherein the at least one selector switch is configured for being selected by an operator of the vehicle;
wherein selection of the at least one selector switch is configured to:
transmit a signal corresponding to a selected drive mode of the vehicle to a controller;
adjust an account balance of a credit account as a function of the selected drive mode; and
transmit a signal from the controller to at least one powertrain module to allow the vehicle to operate in the selected drive mode.
